(19) United States
(12) Patent Application Publication
(10) Pub. No.: US 2008/0172268 A1
(43) Pub. Date: Jul. 17, 2008

(54) SYSTEM AND METHOD OF ENHANCING COST PERFORMANCE OF MECHANICAL SYSTEMS INCLUDING LIFE-LIMITED PARTS

(75) Inventor: Ronald Wingenter, San Antonio, TX (US)

Correspondence Address: TOLER LAW GROUP, 8500 BLUFFSTONE COVE, SUITE A201, AUSTIN, TX, 78759, US

(73) Assignee: Standard Aero (San Antonio), Inc., San Antonio, TX (US)

(21) Appl. No.: 11/864,108

(22) Filed: Sep. 28, 2007

Related U.S. Application Data
(63) Continuation-in-part of application No. 11/175,533, filed on Jul. 6, 2005.
(60) Provisional application No. 60/643,476, filed on Jan. 13, 2005.

(51) Int. Cl. G06Q 10/00

(52) U.S. Cl. 705/7

(57) ABSTRACT

A method is provided that includes receiving a primary work scope comprising a set of tasks associated with maintenance of the mechanical system including a life-limited part. The method further includes generating a set of work scopes for the mechanical system, where each work scope of the set of work scopes includes the primary work scope and at least one additional task associated with maintenance of the mechanical system. At least one work scope of the set of work scopes includes a maintenance task related to the life-limited part. The method further includes estimating an operating time and a cost performance parameter for the mechanical system based on each work scope of the set of work scopes and providing an enhanced work scope. The enhanced work scope has an operating time that is greater than a threshold.

### CROSS-REFERENCE TO RELATED APPLICATION(S)

The present application is a continuation-in-part of and claims priority from U.S. patent application Ser. No. 11/175,533, filed Jul. 6, 2005, entitled “SYSTEM AND METHOD FOR ENHANCING COST PERFORMANCE OF MECHANICAL SYSTEMS,” which application is incorporated herein by reference in its entirety and which claims priority from U.S. Provisional Patent Application No. 60/643,476, filed Jan. 13,2005, entitled “SYSTEM AND METHOD FOR ENHANCING COST PERFORMANCE OF MECHANICAL SYSTEMS,” naming inventor Ronald Wingenter, which application is incorporated by reference herein in its entirety.

### FIELD OF THE DISCLOSURE

The present disclosure is generally relates to systems and methods of enhancing cost performance of mechanical systems including life-limited parts.

### BACKGROUND

Modern mechanical systems include many complex modules that are difficult to maintain and repair. Various types of mechanical systems, including engines, process control systems, and the like, as well as small mechanical devices with many discrete components may be difficult to diagnose and repair. Such difficulties may also apply to airplane engines, and especially for jet engines, such as those on modern commercial and on military aircraft. For the airline industry and for militaries, costs associated with maintenance and repair of a fleet of aircraft are high. However, failure to maintain an aircraft may lead to accidents that cost lives and that result in the loss of expensive aircraft.

To prevent such accidents, the airline industry, other organizations, and governmental agencies that support aircraft, such as the military, frequently inspect aircraft systems including aircraft engines. When performing an inspection of an aircraft engine, an inspector may notice a module or component that is in a state of disrepair and may order the engine to be removed from the aircraft for maintenance of the module or component. This type of engine removal may be referred to as an unscheduled removal. Once an engine has been removed from the aircraft, additional problems may be discovered and associated repair costs may increase.

In general, repair and maintenance of an engine is expensive and, thus, commercial airlines, other organizations, and governmental agencies have attempted to estimate costs associated with engine maintenance and repair. Commercial airlines have begun to utilize statistical reliability analysis techniques to plan and to budget for equipment maintenance, to predict costs associated with product warranties, and to make decisions about maintenance of a particular device.

Traditional statistical reliability analysis and, in particular, Weibull analysis rely on failure data related to a population of devices. If a complete data set is available (i.e., failure ages are known for each device within the population), statistical reliability analysis, such as Weibull analysis, can be applied to the individual components and individual failure modes and associated results can be combined to provide predictions, such as a meantime-to failure for a particular device, a percentage of devices that may fail at a particular time or before a particular age, a statistical distribution of failure ages, and other statistical measures of device failures. The age of a particular device may be measured in operating times, such as a time-in-service, a time on wing, or other cumulative performance measures, such as mileage, hours, cycles, the number of revolutions, other units, or any combination thereof.

However, a typical population includes devices that have yet to fail, which may be termed “suspensions.” In Weibull analysis, such populations are often denoted as “right censored populations.” While analysis techniques for suspension populations have been developed, these analysis techniques typically rely on snapshots of population data including both the suspension data and failure data.

The reliability of a system can be modeled as the product of the reliabilities of the individual components. The Weibull parameters for each component describe its individual reliability. The product of these reliabilities can be expressed as a function of time, cycles or some other parameter related to time in service. The combined function can then be solved to yield the time at which the reliability is equal to a predetermined value, most commonly 0.5. Generally, this time represents the median time to removal for unscheduled maintenance without consideration for life-limited components. This practice results in inaccurate failure and removal estimates.

In particular, such maintenance and repair estimates typically fail to properly combine the effects of scheduled engine removals driven by a life-limited component and of unscheduled repairs. For example, certain components within an engine may have an expected service life defined by a manufacturer or by a regulatory agency, such as the Federal Aviation Administration (FAA), which may be expressed in terms of hours of use or cycles. As used herein, the terms “lifed-component”, “life-limited part,” and “life-limited component” refer to an item that has an assigned service life, which may be expressed in terms of hours, cycles or some other usage parameter. When a lifed-component of an engine consumes its service life (i.e. runs out of hours or cycles), the engine must be removed and sent to a repair shop to replace the life component, even if the lifed-component is still operating correctly. There may also be a situation in which the engine fails for another reason prior to reaching the time when a removal is required for the life-limited part.

### BRIEF DESCRIPTION OF THE DRAWINGS

The present disclosure may be better understood, and its numerous features and advantages made apparent to those skilled in the art by referencing the accompanying drawings.

FIG. 1 is a block diagram of a particular illustrative embodiment of a computational system to estimate an impact of life-limited components and to produce an enhanced work scope for maintenance and repair;

FIG. 2 is a block diagram of a particular illustrative embodiment of a distributed computational system to estimate an impact of life-limited components and to produce an enhanced work scope for maintenance and repair;

FIG. 3 is a flow diagram of a particular embodiment of a method of performing maintenance on a mechanical system;

FIG. 4 is a particular illustrative example of a graph of reliability versus time since overhaul for a particular mechanical system;

FIG. 5 is a graph of a particular illustrative example of a histogram of the statistical removals expected from 1000 engines, which do not include any life-limited components that have a life remaining that is short enough to impact the estimated time on wing;

FIG. 6 is a graph of a second particular illustrative embodiment of a histogram of the statistically expected removals when a life-limited component with a life remaining of 2600 hours is included in each of the engines;

FIG. 7 is an illustrative graph of reliability versus operating hours for a particular mechanical system including a life-limited component that is limited to 2600 operating hours and illustrating a computation of Mean Time to Repair (MTTR) combining effects of system failures due to reliability and effects of scheduled service due to life-limited components;

FIG. 8 is an illustrative flow diagram of a particular embodiment of a method of generating a reliability prediction for an aircraft engine using a reliability model that includes a reliability model of life-limited components of the aircraft engine;

FIG. 9 is an illustrative block diagram of a particular embodiment of a method of generating a reliability model including life-limited components for use by a predictor tool;

FIG. 10 is an illustrative general diagram of a particular embodiment of a system for generating an enhanced work scope based on reliability models including life-limited components;

FIG. 11 is a flow diagram of a particular illustrative embodiment of a method of providing an enhanced work scope based on a primary work scope;

FIG. 12 is a flow diagram of a particular illustrative embodiment of a method of generating a reliability model of a mechanical system that includes a life-limited component;

FIG. 13 is a flow diagram of a particular illustrative method for enhancing cost performance using a computational system, such as the exemplary computational system of FIG. 1; and

FIG. 14 is a diagram of a particular illustrative embodiment of a user interface for one embodiment of a work scope software application;

FIG. 15 is a diagram of another particular illustrative embodiment of a user interface of the work scope software application;

FIG. 16 is a diagram of a particular illustrative embodiment of a table illustrating results of a cost driven work scope optimization with “CDO” in the action column denoting a Cost Driven Overhaul of still functioning components because of reliability or life-limited components.

FIG. 17 is a graphical representation of a particular illustrative embodiment of a cost-based output with each dot on the chart showing the cost per hour and mean time to failure associated with a particular work scope;

FIG. 18 is a graphical representation of a first 60 entries in an exemplary entry table illustrating results of applying a particular work scope to a particular mechanical system, such as an aircraft engine; and

FIG. 19 is a table illustrating data related to reliability and cost computations for one of the work scopes illustrated in FIGS. 17 and 18.

### DETAILED DESCRIPTION OF THE DRAWINGS

In general, embodiments of systems and methods disclosed herein may be utilized to statistically estimate the time on wing or time until next removal of an aircraft engine, for example. Such systems and methods may account for overall system and component reliability and may take into consideration life-limited components. Such systems and methods may be used to assist service personnel in making service-related decisions to improve efficiency with respect to maintenance and repair for both scheduled and unscheduled service.

In one particular embodiment, the disclosure is directed to a method for enhancing cost performance of a mechanical system, such as an aircraft engine. The mechanical system may be inspected and a primary work scope determined. The primary work scope generally includes a set of tasks associated with maintenance of the mechanical system or a set of modules designated for overhaul, repair or replacement. The primary work scope is entered into a computational system. The computational system determines an enhanced work scope based on the primary work scope. The enhanced work scope includes the primary work scope and at least one additional task related to maintenance of the mechanical system, such as maintenance related to one or more life-limited parts of the mechanical system. The enhanced work scope is associated with an estimated operating time of the mechanical system that is greater than a target or threshold operating time and is associated with a cost that is less than costs associated with other possible work scopes that are greater than the target.

In a particular example, the enhanced work scope can include the set of tasks of the primary work scope and one or more additional tasks that are estimated to extend an operating time of the mechanical system without unnecessary maintenance costs. The enhanced work scope can be provided to maintenance personnel. Further, data determined after the tasks are completed, such as the actual cost of the maintenance or the actual operation time of the mechanical system between repairs, may be entered into the computational system to improve reliability and cost models.

In general, a customer may define a target or threshold operating time, which is a minimum time that the customer wants the mechanical system to operate without experiencing a failure or without requiring maintenance. The computational system is adapted to utilize performance data, historical data, life-limited parts data, available shop assets, reliability models, and cost models to determine an estimated operating time for the mechanical system based on execution of a given work scope and an estimated cost for performing the given work scope. The computational system may include a work scope evaluation tool to determine a desired work scope based on a cost performance parameter, such as cost per unit time.

In general, operation time or operating time refers to an amount of time or an amount of cycles that the mechanical system and/or modules of the mechanical system are in operation (e.g. a number of batches in a process control environment, a number of times a mechanical operation is performed, a number of flying hours for an aircraft engine, and the like) before a failure event (such as an engine failure, a module failure, and the like);

In a particular embodiment, a method is provided that includes receiving a primary work scope comprising a set of tasks associated with maintenance of the mechanical system, which includes a life-limited part. The method further includes generating a set of work scopes for the mechanical system, where each work scope of the set of work scopes includes the primary work scope and at least one additional task associated with maintenance of the mechanical system. At least one work scope of the set of work scopes includes a maintenance task related to the life-limited part. Additionally, the method includes estimating an operating time and a cost performance parameter for the mechanical system based on each work scope and includes providing an enhanced work scope. The enhanced work scope has an operating time that is greater than a threshold and has an enhanced cost performance parameter.

In another particular embodiment, a system includes a work scope generator, a predictor tool, and a work scope evaluation unit. The work scope generator receives a primary work scope including a set of tasks related to maintenance of a mechanical system and generates a set of work scopes. Each work scope of the set of work scopes includes the primary work scope and at least one additional task associated with maintenance of the mechanical system. At least one work scope of the set of work scopes includes at least one maintenance task related to a life-limited part. The predictor tool generates an estimated operation time of the mechanical system and a cost performance parameter for each work scope. The work scope evaluation unit receives the estimated operation time and the estimated cost performance parameter and determines an enhanced work scope from the set of work scopes that includes an operating time that is greater than a threshold and that includes an enhanced cost performance parameter.

In still another particular embodiment, a method of performing reliability analysis for components of a mechanical system is provided that includes accessing failure data related to a plurality of components of a mechanical system, performing a reliability analysis for each of the plurality of components of the mechanical system based on the failure data, and providing a graphical user interface to display a reliability analysis related to a life-limited component of the plurality of components and to receive user inputs related to an end of life indicator to adjust the reliability analysis of the life-limited component. The method further includes generating a reliability model of the mechanical system using the adjusted reliability analysis of the life-limited component.

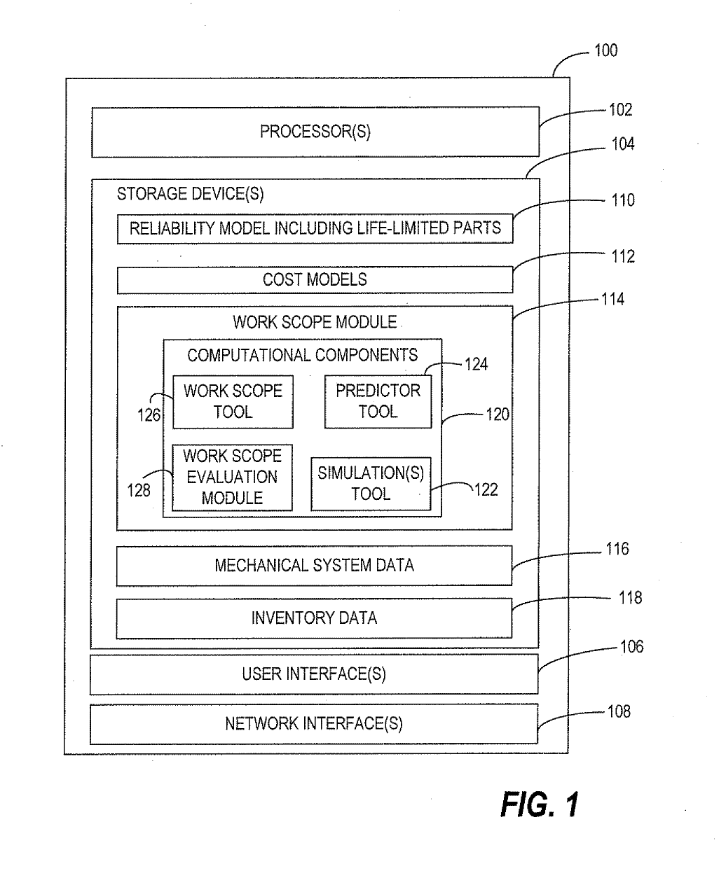

The systems and associated methods may be implemented in a computational system, such as a laptop or desktop computer, depending on portability and speed preferences. FIG. 1 is a block diagram of a particular illustrative embodiment of a computational system 100 to estimate an impact of expired service life components and to produce an enhanced work scope for maintenance and repair. The computational system 100 may include a processor 102, one or more storage devices 104, one or more user interfaces 106, and one or more network interfaces 108. For clarity, the system 100 is discussed as if a single storage device 104 is included; however, it should be understood that the system 100 may utilize multiple storage devices and that various stored elements may be distributed among the storage devices.

Referring to FIG. 1, the storage device 104 may be accessible to the processor 102. The storage devices 104 may include processor-executable instructions and data, which can be accessed by the processor 102 to determine an enhanced work scope for a mechanical system. Such storage devices 104 may include a hard disk drive, a floppy drive, a compact disc read only memory (CD-ROM), a CD-R (compact disc recordable drive), a CD-RW (compact disc re-writable drive), a DVD (digital video disc), a random access memory (RAM), a flash memory, other memory, or any combination thereof. The storage device 104 may also include storage area networks and other types of distributed memories. The storage device 104 is configured to store data and processor-executable instructions, such as reliability models including life-limited parts 110, cost models 112, a work scope module 114, mechanical system data 116, and inventory data 118.

Each of the reliability models including life-limited parts 110 may include historical data related to failure of a particular part, a component or a module of the mechanical system, as well as manufacturer test data relating to reliability of various components over time. The cost models 112 may include data related to the costs associated with various replacement parts, service-related costs, costs associated with a system being out of service, and historical data derived from performance of actual service related to similar work scopes.

The work scope module 114 may include computational components 120, such as a simulation tool 122, a predictor tool 124, a work scope tool 126, and a work scope evaluation module 128, which can be executed by the processor 102 to estimate one or more work scopes. For example, the simulation tool 122 may be utilized to perform Monte Carlo simulations and other types of statistical simulations of a mechanical system according to the reliability models including life-limited parts 110 to simulate an operating life of the mechanical system. The work scope tool 126 may be adapted to generate a set of work scopes based on a primary work scope, where each work scope of the set of work scopes includes the primary work scope and at least one additional task related to the maintenance of the mechanical system. One of the additional tasks may include a maintenance task associated with a life-limited part. The predictor tool 124 may generate predictions relating to operation of the mechanical system using the reliability models including life-limited parts 110, the simulation results from the simulation tool 122, and other information related to the mechanical system. The predictor tool 124 may be adapted to receive a work scope and to estimate an operating time for the mechanical system if the particular work scope is executed. The predictor tool 124 may also be adapted to generate a cost estimate based on the cost models 112 for a given work scope. The predictor tool 124 may generate a cost performance parameter, which may be a function of the estimated operating time and the cost estimate for each work scope. In one particular embodiment, the predictor tool 124 generates a cost estimate, an estimated operating time, and a cost performance parameter for each work scope of a set of work scopes produced by the work scope tool 126.

The work scope evaluation module 128 may determine a subset of the set of work scopes that have an estimated operating time that is greater than a threshold. The threshold may be a target amount of time that a customer desires a system to be in operation between failures, for example. The target amount of time may be based on an industry average, based on performance standards of the customer, based on manufacturer specifications, based on other criteria, or any combination thereof. The work scope evaluation module 128 may then select a work scope from the subset that has a desired cost performance parameter In one particular embodiment, the work scope evaluation module 128 includes an artificial intelligence engine. In another particular embodiment, the work scope evaluation module 128 is adapted to execute fuzzy logic operations. In another particular embodiment, the work scope evaluation module 128 may be adapted as a neural network, which may learn from historic data.

In one particular embodiment, the desired cost performance parameter may be a lowest maintenance cost of the subset of work scopes that have an estimated operating time that is greater than a threshold. In one example, the work scope module 114 when implemented by the processor 102 accesses the reliability models including life-limited parts 110 to determine an expected operation time for a particular work scope and accesses the cost models 112 to determine an expected cost per unit operation time. The work scope module 114 may determine an enhanced work scope having a particular operation time that is greater than a pre-determined threshold and a lowest cost per unit operation time. For example, the customer may define a threshold of 3000 hours for a desired target amount of time in operation between failures. The work scope tool 126 may generate a set of work scopes and the predictor tool 124 may generate a cost estimate and an estimated operating time for each work scope. The work scope evaluation module 128 may select an enhanced work scope from the set of work scopes. In this instance, an enhanced work scope may include the primary work scope and an additional task related to a life-limited part. The enhanced work scope may have an estimated operating time that is greater than 3000 hours. Additionally, the enhanced work scope may have an estimated cost that is less than other work scopes that also have estimated operating times that are greater than 3000 hours. Thus, the work scope evaluation module 128 is adapted to select a work scope that satisfies the threshold of the customer and that keeps associated costs low relative to other possible work scopes.

The mechanical system data 116 may include data associated with current performance of the mechanical system, data associated with a history of various parts within the mechanical system, and the like. The inventory data 118 may include a list of available shop assets, including parts, components and modules for use in the mechanical system. The work scope module 114 may also include information related to the mechanical system data 116 to determine additional tasks to add to the primary work scope, and may utilize the inventory data 118 to estimate costs, both in terms of the cost of obtaining a component and in terms of the lost opportunity cost in terms of the time that the mechanical system is out of service.

The user interfaces 106 may include a software interface, such as a graphical user interface for human interaction. Additionally, the user interfaces 106 may include an input interface for coupling to an input device, such as a touch screen, a keyboard, a mouse, a pen device, and the like. The user interfaces 106 may also include a display interface, such as a monitor. For example, a user may utilize the user interfaces 106 to input data associated with the mechanical system for storage in an area of the storage devices 104 including the mechanical system data 116.

The network interfaces 108 may be responsive to a communications network, such as a wireless network, a wired communications networks, or both wired and wireless networks. Such communications networks may include Ethernet networks and networks conforming to Wi-Fi, Bluetooth®, and Wi-Max standards, for example. In a particular embodiment, the network interfaces 108 may communicate data from the processor 102 to the communications network to acquire additional data or model parameters associated with a specific mechanical system from a remote system or to communicate results to the remote system.

In operation, the system 100 provides a user interface to receive a primary work scope including a set of tasks related to maintenance of a mechanical system. The processor 102 may access the reliability models including life-limited parts 110, the cost models 112, the predictor tool 124 of the work scope module 114, the mechanical system data 116, the inventory data 118, or any combination thereof to generate a set of work scopes. Each work scope of the set of work scopes includes the primary work scope and at least one additional task associated with maintenance of the mechanical system. At least one work scope of the set of work scopes may include a maintenance task related to a life-limited part. The predictor tool 124 generates an estimated operating time of the mechanical system and a cost performance parameter for each work scope of the set of work scopes.

The work scope evaluation module 128 receives the estimated operation time and the estimated cost performance parameter and determines an enhanced work scope from the set of work scopes. The enhanced work scope is associated with an operating time that is greater than a threshold and includes an enhanced cost performance parameter. For example, if a customer defines a threshold as a target operation time of 3500 operating hours, the enhanced work scope is associated with an estimated operation time that is greater than 3500 hours. The enhanced cost performance parameter may be an estimated cost that is less than other work scopes that also exceed the target operation time. In one particular illustrative embodiment, the enhanced work scope includes the primary work scope and at least one additional task related to maintenance of a life-limited part, where the enhanced work scope has an estimated operating time that is greater than the target operation time specified by the customer and that has a lowest cost. In another particular embodiment, the enhanced work scope has an estimated operating time that is greater than the threshold and that has a cost performance parameter that is a longest estimated operating time with a lowest associated cost relative to the other work scopes.

In general, the life-limited part is a component of the mechanical system that includes a pre-determined life-cycle limit that defines an operating time limit for the mechanical system. For example, in the context of airplane engines, a regulatory agency, such as the Federal Aviation Administration (FAA), may specify a life limit for a particular component, requiring that the component must be replaced before the life limit of the component is exceeded. In such instances, the component must be replaced whether or not the component exhibits signs of wear. When the limiting life is reached, the reliability of the component in effect goes to zero and drives the reliability of the engine system to zero. In one particular embodiment, the work scope module 114 may determine from the mechanical system data 116 that a life-limited component is approaching its specified life-limit and add a task related to maintenance of the life-limited component to the primary work scope for each work scope of the set of work scopes. In a particular example, the pre-determined life-cycle limit may be defined by a manufacturer of the life-limited part or may be specified by a regulatory agency.

In one particular embodiment, the system 100 may include a graphical user interface to display the reliability model for each component of the mechanical system and to receive user input to adjust the reliability model for a particular life-limited part to produce an adjusted reliability model.

It should be understood that, while the computational system 100 is shown as a single integrated unit, the computational system 100 may be implemented such that one or more components reside in separate devices. The components, models, modules, data, and processors may be directly accessible or remotely accessible via one or more networks. In addition, the modules, models, and data may be stored on the same medium or separate media.

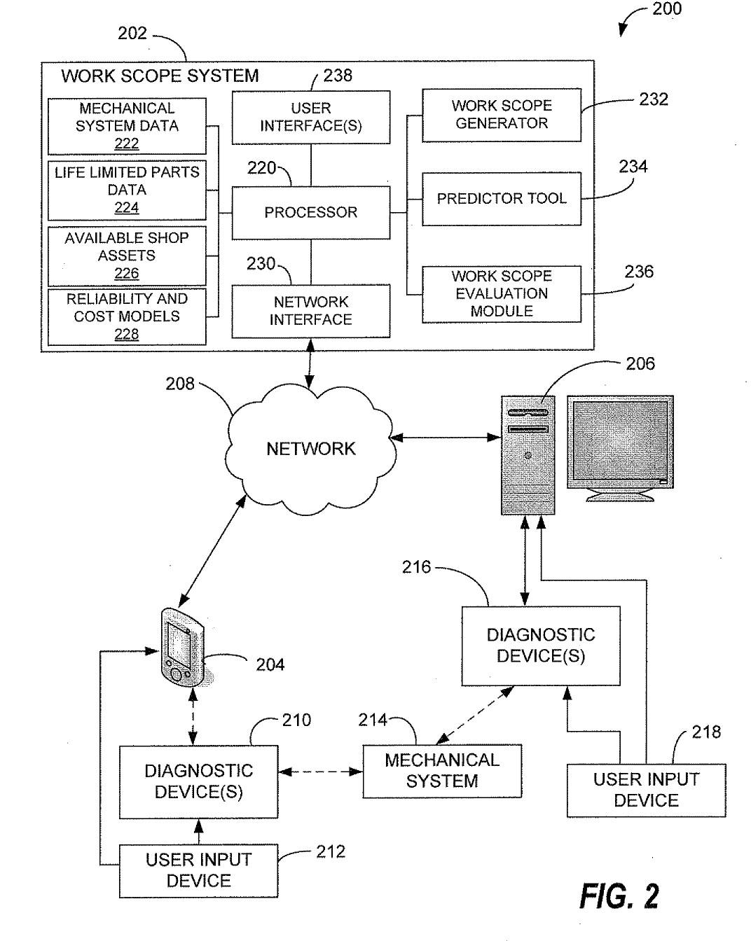

FIG. 2 is a block diagram of a particular illustrative embodiment of a distributed computational system 200 to estimate an impact of life-limited components and to produce an enhanced work scope for maintenance and repair of a mechanical system. In one exemplary embodiment, the mechanical system may be an aircraft engine.

The system 200 includes a work scope system 202, a handheld device 204 and a computing system 206 that are communicatively coupled via a network 208. The handheld device 204 may be coupled to one or more diagnostic devices 210 and to a user input device 212 to receive inputs related to maintenance required by a mechanical system 214, such as an aircraft engine, an automotive engine, or another type of mechanical system that requires maintenance that may involve a life-limited component. The computing system 206 may be coupled to one or more diagnostic devices 216 and to a user input device 218 to receive inputs related to maintenance required by the mechanical system 214.

The work-scope system 202 includes a processor 220 and data associated with the mechanical system, such as mechanical system data 222, life-limited parts data 224, available shop assets 226, and reliability and cost models 228. The work scope system 202 also includes a network interface 230 that is adapted to communicatively couple the work scope system 202 to the network 208. Additionally, the work scope system 202 includes a work scope generator 232, a predictor tool 234, a work scope evaluation module 236, and one or more user interfaces 238. The processor 220 is adapted to access the mechanical system data 222, the life-limited parts data 224, the available shop assets 226, and the reliability and cost models 228. The work scope system 202 is adapted to receive a primary work scope, either via the network interface 230 or via the user interface 238, and to access the work scope generator 232 to generate a set of work scopes, which include the primary work scope and at least one additional task associated with maintenance of the mechanical system 214.

The processor 220 may access the predictor tool 234 to generate an estimated operating time and an associated cost per unit time for the mechanical system related to each work scope. The processor 220 may then access the work scope evaluation module 236 to determine an enhanced work scope from the set of works scopes based on the estimated operating time and the cost per unit operating time.

In operation, the work scope system 202 receives diagnostic information associated with the mechanical system from either the network 208 via the network interface 230 or from the one or more user interfaces 238. In one embodiment, diagnostic information associated with the mechanical system 214 is input by a user via user-input device 212 to the handheld device 204, which transmits the information to the work-scope system 202 via the network 208. In one particular embodiment, a diagnostic device 210 may be coupled to the mechanical system 214 to derive performance information and other data from the mechanical system 214 and to provide the information to the handheld device 204.

In an alternative embodiment, the computing system 206 may receive diagnostic information related to the mechanical system 214 from the user-input device 218, from one or more diagnostic devices 216 coupled to the mechanical system 214, or any combination thereof The computing system 206 may transmit the diagnostic information into the work-scope system 202 via the network 208.

The work-scope system 202 may process the received diagnostic information to generate a primary work-scope. The processor 220 may then utilize the work-scope generator 232, the predictor tool 234, and data associated with maintenance of a mechanical system, such as the mechanical system data 222, the life-limited parts data 224; the available shop assets 226, and the reliability and cost models 228 to generate a set of work-scopes based on the primary work-scope. Each work-scope of the set of work-scopes may include an estimated operating time and a cost per unit operating time. The processor 220 may utilize the work-scope evaluation module 236 to evaluate the set of work scopes to identify a desired (enhanced) work-scope. The desired work-scope may be selected based on a number of parameters including a cost of the maintenance, an operating time, or a function of cost and operating time. In one particular embodiment, the desired work-scope is selected based on an operating time that exceeds a predetermined threshold. In another alternative embodiment, the desired work-scope is selected from the set of work scopes to have an operating time that exceeds a predetermined threshold and to have an estimated cost per unit operation that is less than other work-scopes that exceed the threshold.

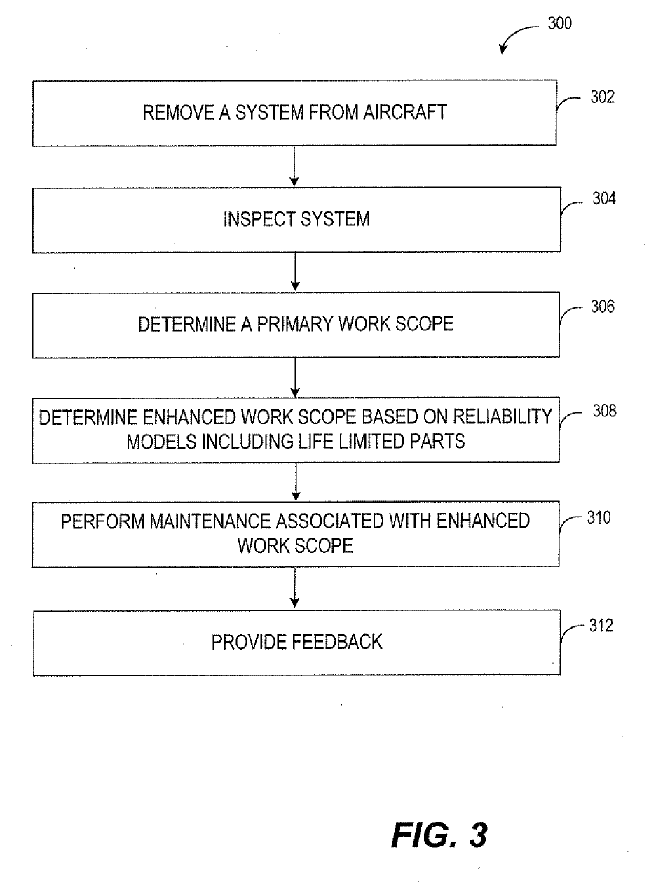

FIG. 3 is a flow diagram of a particular embodiment of a method of performing maintenance on a mechanical system. FIG. 3 illustrates an exemplary method 300 for enhancing cost performance. An initial inspection of an aircraft engine results in an order to remove the engine from the aircraft, as illustrated at 302. Typically, an engine is removed from the aircraft when a condition is noted that involves repairs that cannot be accomplished with the engine installed or when, in order to meet operational requirements, an engine repair while the engine is installed would be too time consuming. For purposes of this discussion, the conditions or failures that result in removal of the engine from the wing are herein called “primary failure.” Typically, once the engine is removed from the wing, an additional inspection is performed on the engine, as illustrated at 304, and a primary work scope is determined, as illustrated at 306. The primary work scope generally includes a set of tasks or a list of engine modules to be repaired or overhauled. When an engine is sent to an intermediate shop, it receives a complete inspection using manuals appropriate for the repair level. While the inspection of an engine on-wing is usually terminated once a condition is found that involves engine removal, the inspection in the shop includes the entire engine. It is not uncommon for other conditions to be found that would also have resulted in engine removal when the complete inspection is accomplished. The failures that are actually found sometimes depend on the sequence of inspection. For this reason there may be more than one “primary failure.”

Engine data and the primary work scope are entered into a computational system to determine an enhanced work scope based on the reliability models including life-limited parts, as illustrated at 308. Generally, the computational system selects a work scope from a set of possible work scopes based, at least in part, on performance criteria. The set of possible work scopes is based on the primary work scope and, typically, the enhanced work scope includes the tasks associated with the primary work scope and optionally additional tasks. If a life-limited part is included in the engine and the life-limited part is approaching its pre-determined life limit, the life-limited part can be included in the enhanced work scope. However, in some cases, the primary work scope may become the enhanced work scope after a determination is made that no life-limited components require service and after a determination is made as to whether the primary work scope meets the performance criteria.

Based on the enhanced work scope, maintenance is performed on the engine, as indicated at 310. For example, the engine modules designated in the enhanced work scope may be overhauled, repaired, or replaced. The actual cost of the maintenance and the resulting maintenance free operation time of the engine may be entered into the computational system as feedback, as indicated at 312. The computational system may adjust the reliability models and cost models based on the feedback data.

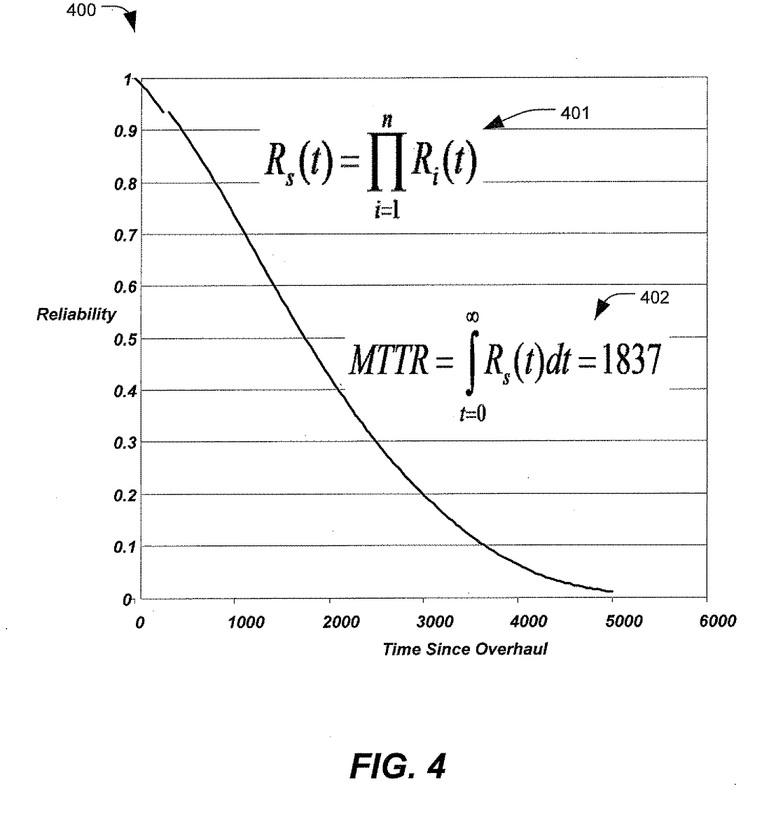

FIG. 4 is an illustrative graph 400 of reliability versus time since overhaul for a particular mechanical system, and in particular a Mean Time to Removal (MTTR) for the particular mechanical system. In a particular illustrative embodiment, the reliability of the system can represent the product of the reliabilities of the individual components and the mean time to failure (MTTF) can represent the integral of the system reliability. In general, the graph 400 represents a reliability model that may be created by characterizing various types of failures experienced by the mechanical system using statistical distributions and by embedding the failure distributions into a Monte Carlo model. The illustrative graph 400 shows the overall system reliability over time for a particular mechanical system based on unscheduled maintenance issues. The reliability (R_{S}) of the mechanical system is the product of the reliabilities of the individual components, as illustrated at 401. The MTTR can be obtained by numerical integration of the reliability curve, as illustrated at 402. The MTTR for the example curve is 1837 hours. The graph 400 does not demonstrate the impact of time-expired or life-limited components on overall system reliability. Over time, however, the graph 400 illustrates that the mechanical system becomes increasingly unreliable until the mechanical system becomes almost completely unreliable at approximately 5000 operating hours, according to the reliability model.

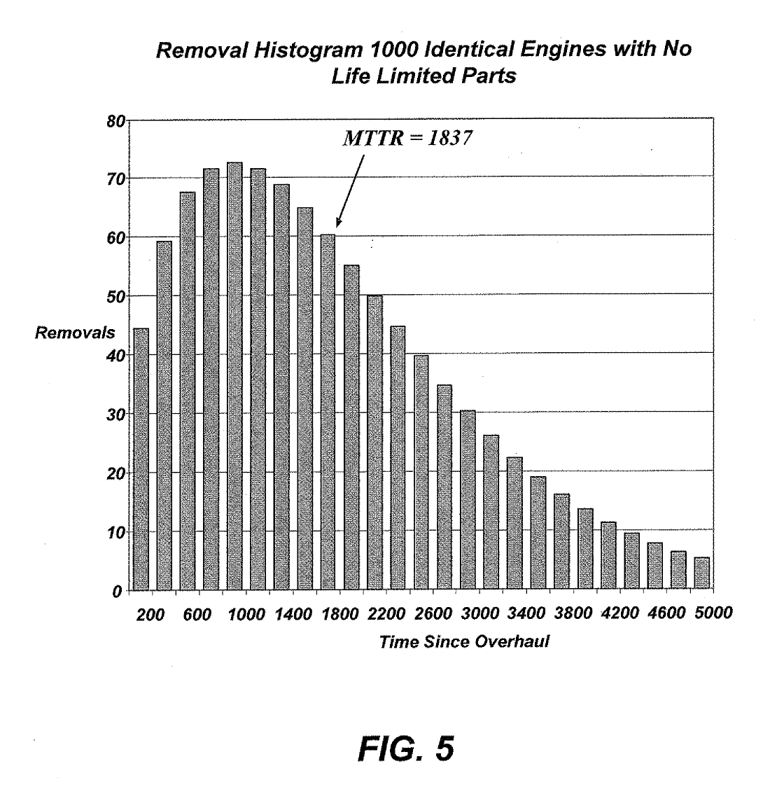

FIG. 5 is an illustrative statistical graph 500 of the expected number of failures in a fleet of 1000 mechanical systems for which the overall reliability curve shown in FIG. 4 applies. In this example, the graph 500 illustrates the expected number of failures without life-limited components that impact the Mean Time to Failure (MTTF).

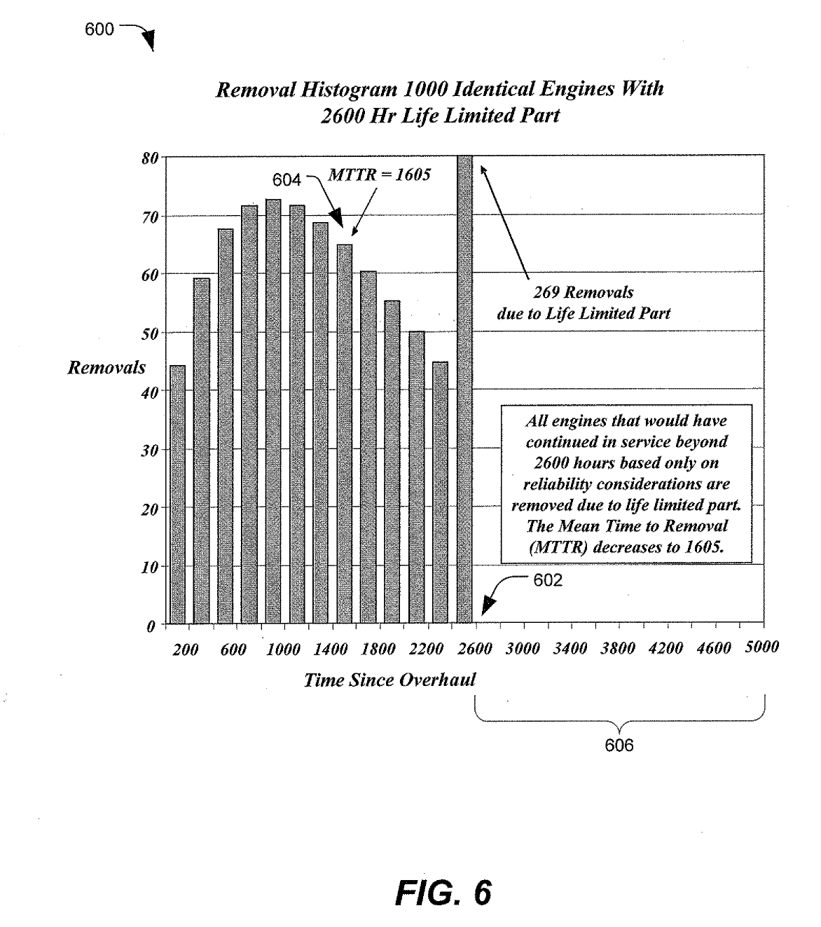

FIG. 6 is an illustrative statistical graph 600 of the expected number of failures in a fleet of 1000 mechanical systems, which use the same example as illustrated in FIGS. 4 and 5, with the inclusion of a life-limited part with a remaining life of 2600 hours. In this example, any of the 1000 mechanical systems that would have lasted beyond 2600 hours will be removed from service at 2600 hours (generally indicated at 602) because of the life-limited component. Accordingly, the graph 600 is truncated relative to the graph 500 illustrated in FIG. 5, since all of the removals that would have occurred after 2600 hours will occur at 2600 hours. In this example, the Mean Time to Removal (MTTR) is reduced to approximately 1605 hours, as indicated at 604.

In general, the mean time to failure (MTTF) for the mechanical system, if it did not include the life-limited part, would be approximately 1837 hours. In contrast, when a life-limited part of 2600 hours is incorporated in the mechanical system, the MTTF is approximately 1605 hours, taking into account the life-limited part removals that would have occurred after 2600 hours, as generally indicated at 606.

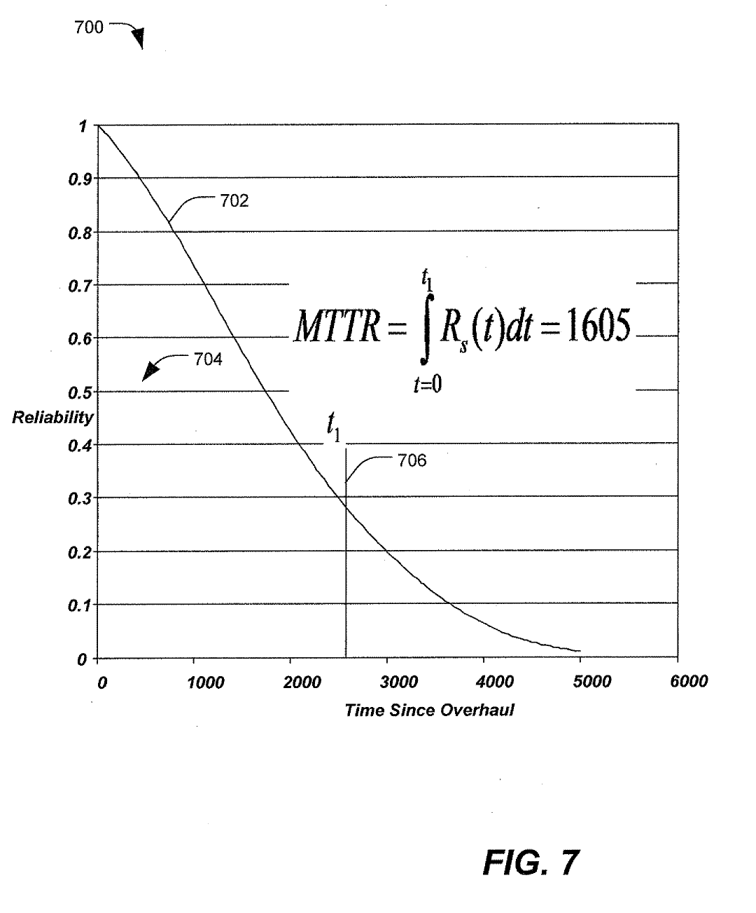

FIG. 7 is an illustrative graph 700 of reliability versus operating hours for a particular mechanical system including a life-limited component that is limited to approximately 10,000 operating hours. The area 704 under the curve 702 represents a mean time to failure for the mechanical system. If a life-limited component is included, the systems of FIGS. 1 and 2 can be used to limit the estimated mean time between failures to a window that is less than the operating life of the life-limited component. The reliability of the part is effectively zero when it reaches the life limit. Additionally, the reliability of the mechanical system, which is the product of the reliabilities of the components, also goes to zero. For example, when the life-limited component is limited to an operating life of approximately 2600 hours as indicated at line 706 (t₁), the distribution of the mean time before failure is reduced to the area under the curve 702 up to the point where the curve 702 intersects the line 706 The line 706 (T₁) represents a boundary condition, such that the mean time before failure may be determined as an integral according to the following equation:

$$MTTR = {\int }_{t = 0}^{{t}_{1}} {R}_{s} ( t ) d t \qquad ( Equation 1 )$$

where R_{S}(t) represents a reliability of the mechanical as a function of time and wherein the reliability is integrated over a time period from zero hours to the life limit of the life-limited component to determine a mean time before failure for the mechanical system. By replacing the life-limited component at or before its life limit is reached at 706 (t₁), failures that would have occurred after 2600 operating hours represented by the area 704 under the curve 702 are preempted.

In general, by varying the life remaining on a component embedded within the mechanical system, the mean time between failures of the mechanical system is altered. For example, reliability, which is the probability that the mechanical system will be operational at this time, is approximately 0.28. This can also be viewed as the proportion of a number of identical systems that would have been still in operation after this point. In this example of 1000 engines, 280 engines would still have been operational after 2600 hours if there were no life-limited components involved. However, when a life-limited part (having 2600 hours remaining before it reaches its life limit) is incorporated in the mechanical system, the reliability is forced to 0 at 2600 hours. Accordingly, the reliability models take into account a life-limited component by integration of the system reliability function from zero to infinity. However, since the reliability goes to zero at the expiration of life remaining for a life-limited part in the system, integration to is performed only within the range of the life limit of the life-limited part.

By confining the integration of the reliability curve to a range from zero to the life limit of the life-limited component, the resulting reliability model may be utilized by a computational system to evaluate an expected operating time of a mechanical system based on one or more work scopes. For example, if the mechanical system includes a life-limited part, the computational system may incorporate tasks associated with replacement of the life-limited parts in order to extend the operating time of the mechanical system beyond a desired threshold. In this manner both the failure distributions for all components and the life-limited components are considered in calculation of expected operating time

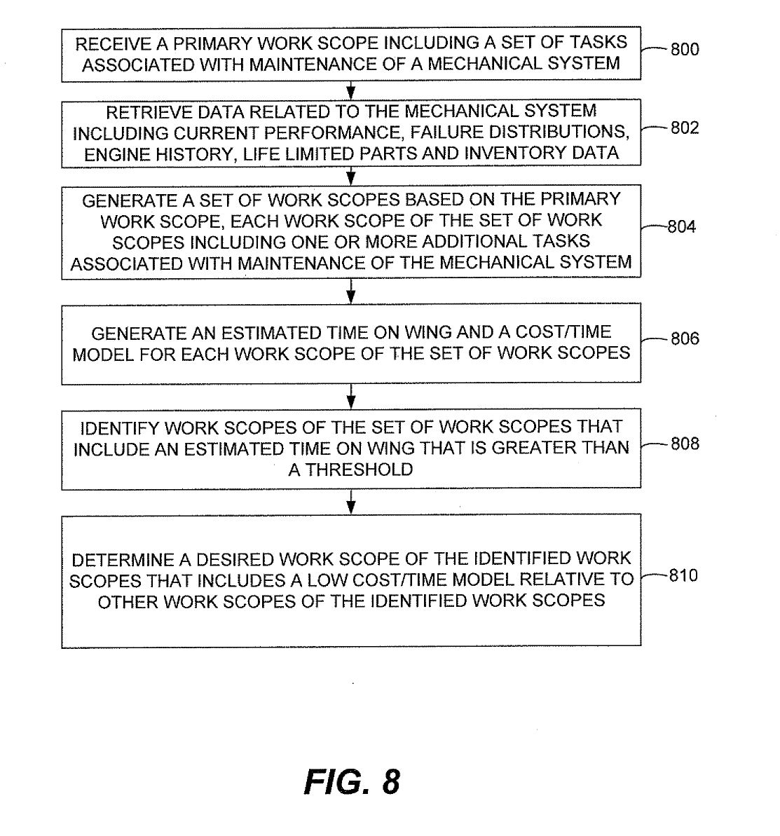

FIG. 8 is an illustrative flow diagram of a particular embodiment of a method of generating a reliability prediction for an aircraft engine using a reliability model that includes a reliability model of life-limited components of the aircraft engine. A primary work scope including a set of tasks associated with maintenance of a mechanical system is received, at 800. Data related to the mechanical system, including current performance data, failure distribution data, engine history data, life-limited parts data, and inventory data, are retrieved, at 802. A set of work scopes based on the primary work scope is generated. Each work scopes or set of work scopes may include one or more additional tasks associated with maintenance of the mechanical system, at 804. An estimated time on wing and a cost/time model for each work scope of the set of work scopes is generated, at 806. Work scopes of the set of work scopes are identified that include an estimated operating time, such as a time on wing, that is greater than a threshold, as indicated at 808. A desired work scope of the identified work scopes is determined that includes a low cost/time model relative to other work scopes of the identified work scopes, at 810.

For example, in one particular embodiment, the mechanical system may be an aircraft engine. A company utilizing the mechanical system may specify a target threshold operating time for the aircraft engine, such as 5000 hours, for example. During routine servicing of the aircraft engine, a primary work scope is generated related to service to be performed on the aircraft engine. A work scope module, such as the work scope module 114 illustrated in FIG. 1, may be used to retrieve data related to the mechanical system and to generate a set of work scopes. Each of the work scopes may include the primary work scope and at least one additional task related to maintenance of the mechanical system. An estimated time on wing and an associated cost may be determined for each work scope. In this particular example, work scopes are identified from the set of work scopes that have an estimated time on wing that is greater than the 5000-hour threshold. From the identified work scopes, an enhanced work scope is determined that has a lowest cost per unit time on wing. Thus, the system may be adapted to select a work scope that exceeds a customer performance criteria (such as time on wing) and that includes an enhanced cost performance parameter (such as a lowest cost per unit time on wing relative to other identified work scopes). Depending on the implementation, longest time on wing may be the desired goal without concern from the cost. Alternatively, the desired work scope may be a longest time on the wing with a work scope that is at or near an average cost of all of the work scopes. In a particular example, the system may allow a user to configure the parameters to identify and select a desired work scope for the particular implementation.

In general, each work scope may include any number of tasks associated with maintenance of the mechanical system. In a particular embodiment, the mechanical system may be an engine for an aircraft. The threshold may be defined by a customer, by a governmental agency, by a manufacturer, or any combination thereof. In a particular example, a manufacturer may determine a life-limit for a particular part based on statistical evaluations of usage-time, failure rates, and other data related to the particular part. In a particular embodiment, the desired work scope may have the lowest cost per unit time of operation. Time may be measured in units, such as cycles, hours of operation, actual time, other units, or any combination thereof

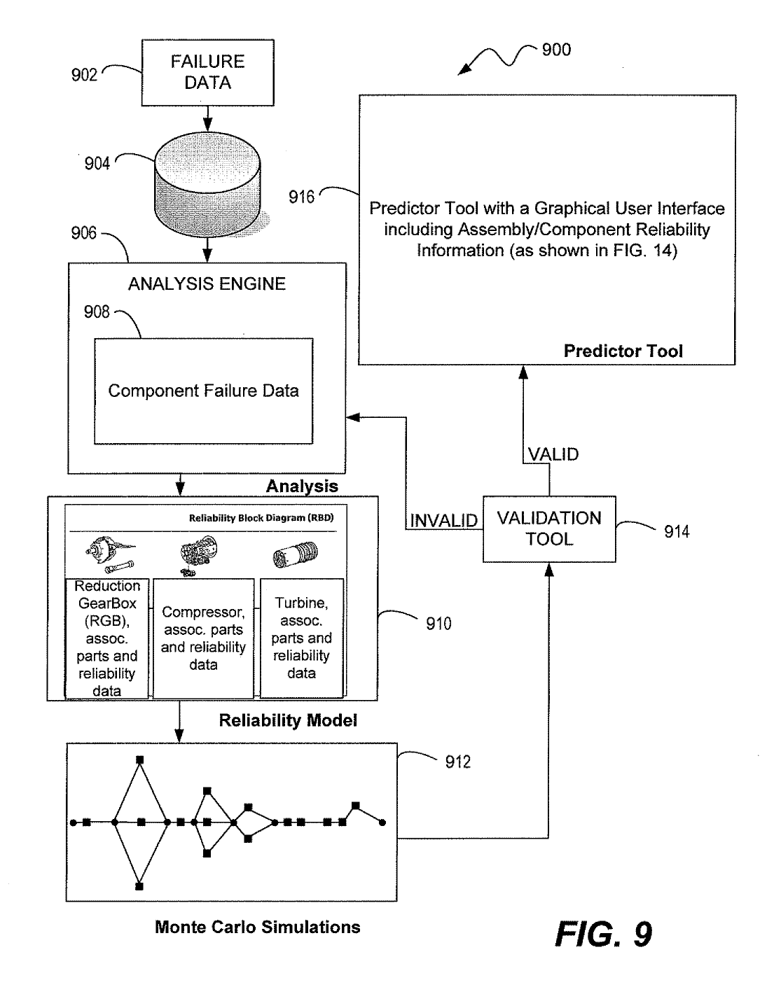

FIG. 9 is an illustrative block diagram 900 of a particular embodiment of a system for developing a predictor tool for use in a computational system for producing work scopes. The diagram 900 includes failure data 902 and data storage 904. The diagram also includes an analysis engine 906, a reliability model 910, Monte Carlo simulations 912, a validation tool 914, and a predictor tool 916.

The failure data of parts of a mechanical system is collected and stored in the data storage 904. An analysis engine 906 accesses the data storage 904 to retrieve the collected failure data 902 and to produce a failure model for each component of the mechanical system based on the available failure data 902. The failure model may be presented in a graphical interface 908, which may be accessible via one or more user interfaces, such as a graphical user interface. A user may utilize a graphical user interface to access and to adjust or modify the failure model. For example, an analysis based on failure data 902 that is collected on parts may not include failure data for life-limited parts, since such parts are required to be removed prior to the expiration of the life-limit. Accordingly, a user interface may be used to access the failure model via a user interface to adjust the life term of a life-limited component within the analysis data.

A reliability model 910 may be generated for each component of the mechanical system based on the failure data from the analysis engine 906. Monte Carlo system simulations 912 may be run for each reliability model to generate an estimated operating time for the particular mechanical system. A validation tool 914 analyzes the available failure data 902 relative to the Monte Carlo simulations 912 to determine if the simulation results and the reliability model that were generated at 910 and 912 are valid. If the validation tool 914 determines that the simulation results from the Monte Carlo Simulations 912 and the reliability model 910 are invalid, the analysis engine 906 re-runs the analysis, the reliability model is re-generated, and new Monte Carlo simulations 912 are run. If the validation tool 914 determines that the reliability model 910 and the resulting Monte Carlo simulations 912 are valid, the validation tool 914 provides the valid reliability model to the predictor tool 916. The predictor tool 916 may apply such reliability models to work scopes related to maintenance of a given mechanical system to generated estimates of the operating time and maintenance costs of the given mechanical system.

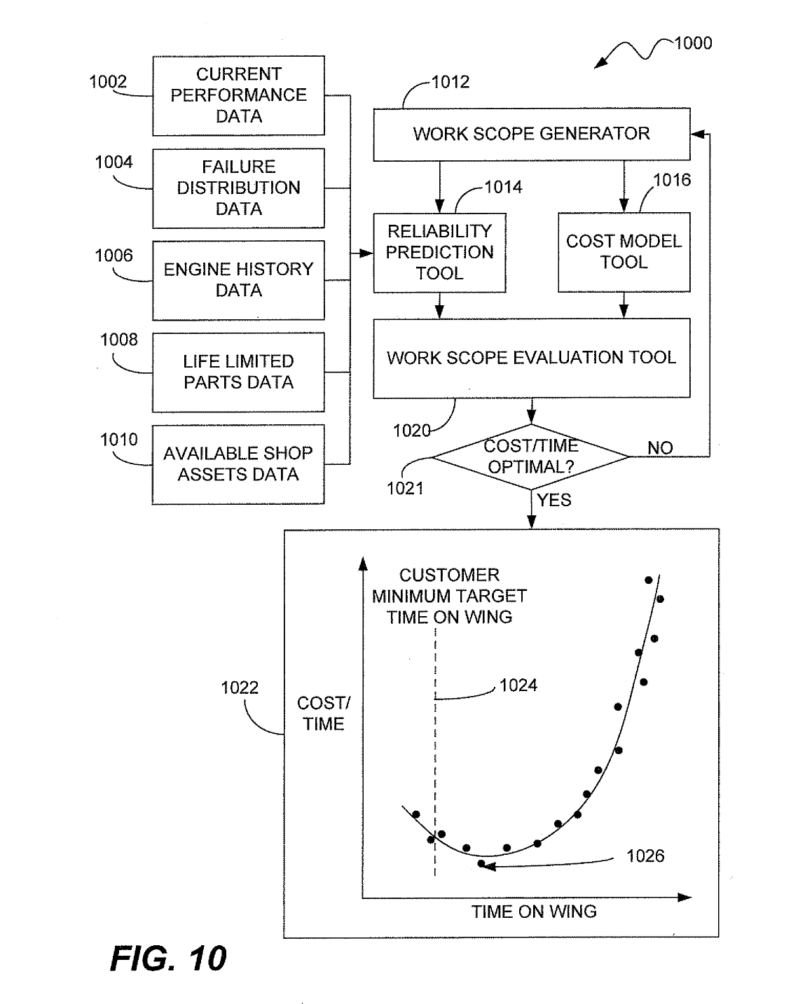

FIG. 10 is an illustrative general diagram of a particular embodiment of a system 1000 for generating an enhanced work scope based on reliability models including life-limited components. The system 1000 includes data such as current performance data 1002, failure distribution data 1004, engine history data 1006, life-limited parts data 1008, and available shop assets 1010. The system 1000 also includes a work scope generator 1012, a reliability prediction tool 1014, a cost model tool 1016, and a work scope evaluation tool 1020, and an output 1022.

In general, the work scope generator 1012 is adapted to receive a primary work scope. The work scope generator 1012 may generate a set of work scopes based on the primary work scope. Each work scope of the set of work scopes may include the primary work scope and at least one additional task associated with maintenance of a mechanical system. One such additional task may relate to maintenance of a life-limited part of the mechanical system. The work scope generator 1012 may provide the set of work scopes to the reliability prediction tool 1014 and to the cost model tool 1016. The reliability prediction tool 1014 may utilize the data, such as the current performance data 1002, the failure distributions data 1004, the engine history 1006, the life-limited parts data 1008, and the available shop assets data 1010, to generate an estimated operating time for the mechanical system based on each of the work scopes of the set of work scopes. The reliability prediction tool 1014 may also supplement the estimated operating time with an estimated out-of-service time for the particular mechanical system, in part based on the availability of particular parts for a given work scope task. For example, if a particular part is not available in the inventory of the available shop assets data 1010, then additional down time may be required to acquire the part and to complete a particular maintenance task. Therefore, performance of that particular work scope that includes the task for which the part is not currently available may increase the amount of time required for a particular maintenance operation.

The estimated operating times for the set of work scopes produced by the reliability prediction tool 1014 and the cost estimated for each particular work scope by the cost model tool 1016 are provided to the work scope evaluation tool 1020. The work scope evaluation tool 1020 determines a subset of the work scopes that have an estimated operating time that is greater than a desired threshold. From that subset, the work scope evaluation tool 1020 evaluates the associated costs predicted by the cost model tool 1016. The cost per unit time relative to the operating time (e.g. time on wing) may be provided to the output 1022, which may present the information in graphical form. The operation of the work scope generator 1012, the reliability prediction tool 1014, the cost model tool 1016, and the work scope of the evaluation tool 1020 may be iterative such that the system 1000 processes each work scope of the set of work scopes until a cost versus time parameter of the particular work scope is suitable at block 1021.

In one particular embodiment, the work scope generator 1012 generates one work scope at a time for processing by the reliability prediction tool 1014 and the cost model tool 1016 and for evaluation by the work scope evaluation tool 1020. In another particular embodiment, the work scope generator 1012 generates a set of work scopes based on the primary work scope, and the set of work scopes may be processed in parallel or in series by the reliability prediction tool 1014 and the cost model tool 1016 and by the work scope evaluation tool 1020.

The output 1022 displays the various work scopes as dots on the graph. The threshold at 1024 is defined as a customer minimum target time on wing (threshold 1024), such that the operating time of the mechanical system is expected to exceed the minimum target time before the work scope evaluation tool 1020 would select the work scope as a desired work scope. In one particular embodiment, the output 1022 plots a u-shaped curve based on the set of work scopes and their associated cost and reliability data. A desired work scope indicated at 1026 is a work scope that exceeds the minimum target customer threshold 1024 and that has a lowest cost per unit time relative to other possible work scopes that exceed the threshold 1024.

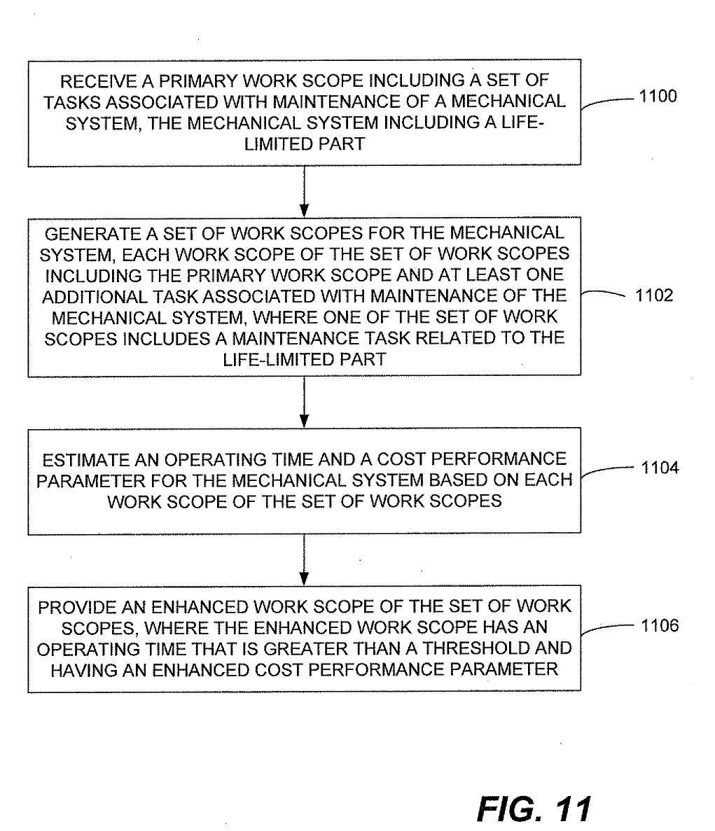

FIG. 11 is a flow diagram of a particular illustrative embodiment of a method of providing an enhanced work scope based on a primary work scope. A primary work scope is received that includes a set of tasks associated with maintenance of the mechanical system, which includes a life-limited part, at 1100, Advancing to 1102, a set of work scopes is generated for the mechanical system. Each work scope of the set of work scopes includes the primary work scope and at least one additional task associated with maintenance of the mechanical system, where at least one work scope of the set of work scopes includes a maintenance task related to the life-limited part. Continuing to 1104, an operating time and a cost performance parameter are estimated for the mechanical system based on each work scope of the set of work scopes. Moving to 1106, an enhanced work scope of the set of work scopes is provided that has an operating time that is greater than a threshold and that has an enhanced cost performance parameter.

In a particular illustrative embodiment, the mechanical system includes a set of components and the method may further include receiving historical data associated with individual components of the set of components. In another embodiment, the historical data may include a number of cycles in operation of each individual component. In another particular illustrative embodiment, the enhanced work scope may be provided by identifying a subset of work scopes of the set of work scopes, where each work scope of the subset of work scopes has an operating time that is greater than the threshold. A work scope of the subset of work scopes may be provided that has an associated cost that is less than an associated cost of other work scopes of the set of work scopes.

In yet another particular illustrative embodiment, the operating time of the mechanical system is estimated based on the reliability model according to the historical data, where the life-limited component defines a limit (or boundary condition) for the operating time. The cost of performing a maintenance operation for each work scope of the set of work scopes may be estimated, and a cost per unit of operating time may be calculated to determine the cost performance parameter. In a particular illustrative embodiment, the set of work scopes may be generated by selecting one or more additional tasks associated with maintenance of the mechanical system that are not included in the set of tasks of the primary work scope, by generating an enhanced work scope including the primary work scope and the one or more additional tasks, and by repeating the selection and the generation iteratively to produce the set of work scopes related to possible combinations of the primary work scope and additional tasks.

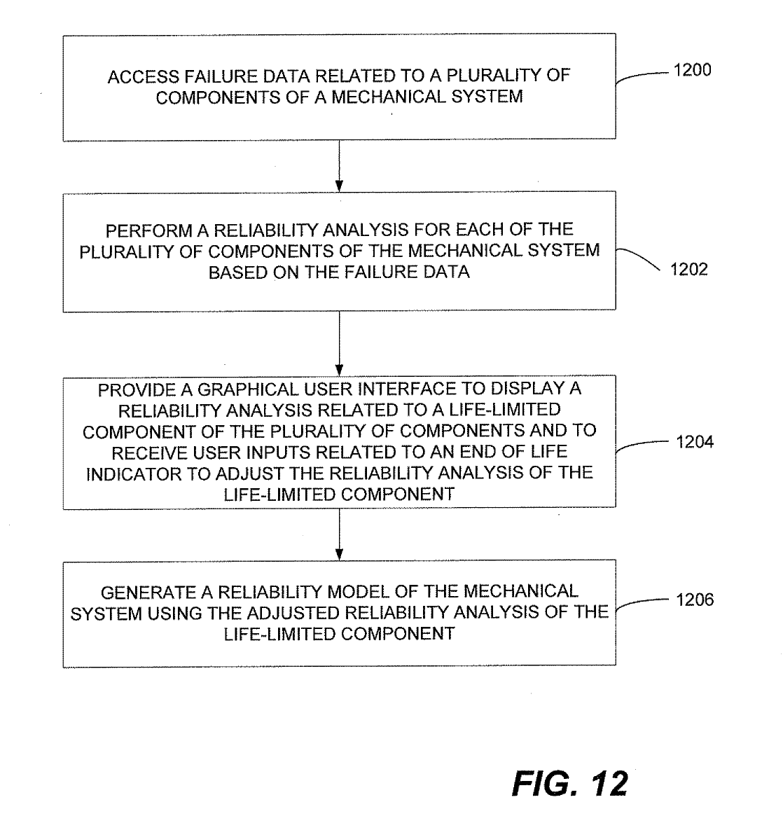

FIG. 12 is a flow diagram of a particular illustrative embodiment of a method of generating a reliability model of a mechanical system that includes a life-limited component. Failure data related to a plurality of components of a mechanical system is accessed, at 1200. A reliability analysis is performed for each of the plurality of components of the mechanical system based on the failure data, at 1202. A graphical user interface is provided to display a reliability analysis related to a life-limited component of the plurality of components and to receive user inputs related to an end of life indicator to adjust the reliability analysis of the life-limited component, at 1204. A reliability model of the mechanical system is generated using the adjusted reliability analysis of the life-limited component, at 1206.

In one particular embodiment, the reliability model includes an estimated operational time related to the mechanical system and the end of life indicator may define a reliability limit of the mechanical system. In another particular embodiment, operational data, including failure and non-failure data associated with the plurality of components, is accessed. A suspension representation of the mechanical system is generated in response to accessing the operational data. The suspension representation includes a representation of components of the mechanical system that have yet to fail as well as scheduled maintenance events, such as maintenance related to life-limited parts. In a particular embodiment, simulations of the mechanical system may be performed using the reliability model to produce simulation results and the simulation results may be compared against historical data to validate the reliability model.

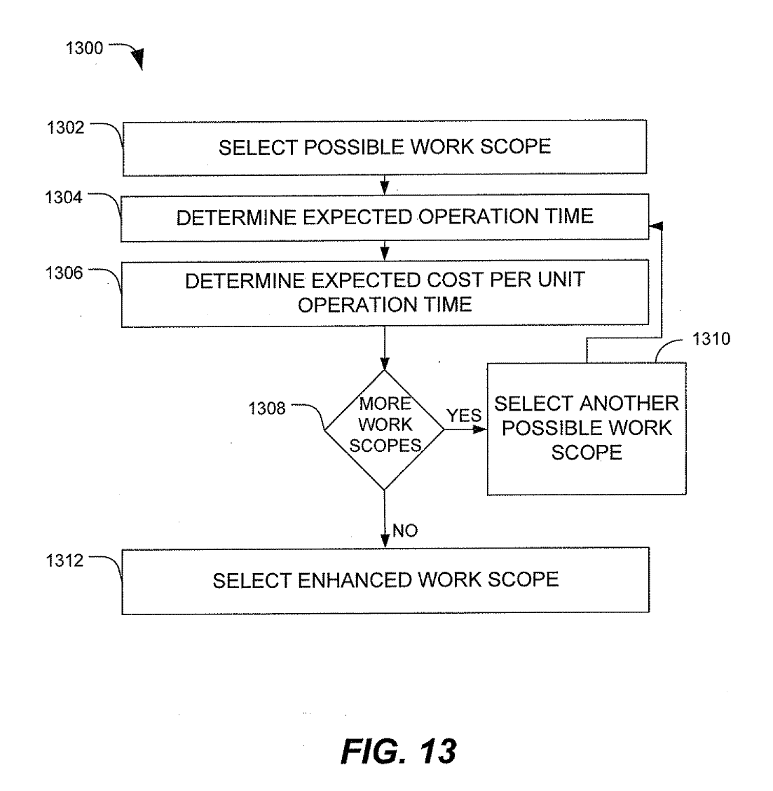

The enhanced work scope may be determined through an exemplary method 1300 illustrated in FIG. 13. A work scope is selected from a set of possible work scopes, as illustrated at 1302. The set of possible work scopes are generally those work scopes that include at least the primary work scope. For example, if an engine has thirteen modules and three are included in the primary work scope, the possible work scopes are those work scopes that include at least the three modules included in the primary work scope. In a particular example, possible work scopes may include 3, 4, 5 and up to 13 modules. The total number of possible work scopes may be, for example 2¹³/2³ or 1024 possible work scopes, where 213 represents a total number of potential work scopes when a system to be repaired has 13 components with no primary failures. For a system that has a module with a primary failure, the decision to overhaul the failed module is assumed and the number of work scope computations is decreased by a factor of 2. In this example, if three of the 13 modules are diagnosed as primary failures, the number of work scope computations is decreased by a factor of 2^{N}, where N represents the number of primary failures (i.e. 3). At least one of the possible work scopes may include a life-limited part that is limited to a particular number of cycles, to a number of operating hours, to another operational parameter, or any combination thereof.

Once a work scope is selected from the possible work scopes, the computational system determines an expected failure free operation time, at 1304. For example, the computational system may use a reliability model or predictor tool. In one particular embodiment, the predictor tool is implemented as a Microsoft Excel® spreadsheet that computes engine time on wing (ETOW) for the engine to be repaired.

Advancing to 1306, an expected cost per unit of operation time (ETOW) is determined for the selected work scope. The ETOW is computed with the assistance of, for example, an iterative Visual Basic for Applications (VBA) routine using the failure distributions (e.g., Weibull curves) for each of the modules plus factors accounting for other failures. The computational system may access a cost model to determine expected costs and divide these expected costs by the ETOW. In one particular embodiment, the cost model models costs associated with unexpected repairs (termed “sunshine costs”), engine module use costs, premature removal risk, and engine module residual value. The cost model may also include costs associated with availability/non-availability of the aircraft, transportation costs for the failed and replaced engine and engine modules, cost of maintaining spares, cost of actual removal and replacement of the engine on the aircraft, engine test cost, and potential cost of functional test flights.

When the engine is disassembled for repair, other conditions are often found that require repair in accordance with manuals used in the repair shop. These conditions are not visible while the engine is assembled. Therefore, the actual work-scope performed on an engine in the intermediate shop and the cost may be considerably larger than the planned work scope (i.e., the primary work scope or the enhanced work scope). The cost of repair of these “hidden” conditions is often referred to as “sunshine” cost because the defects are not visible until the engine is disassembled. The sunshine costs vary depending on the specific primary failure(s) and the level of disassembly required to repair the failure. The sunshine cost is often a large percentage of the total cost of repair for a particular engine removal.

On an exemplary engine, stage 1 and stage 2 fan stators and the fan rotor are removed from the front of the engine and everything else is disassembled from the rear. The last two components that may be separated are the compressor and the fan frame. Removal of the fan shaft or inlet gearbox requires major disassembly, but primary failures are not common on these items. As a result, a greater degree of disassembly is associated with greater sunshine cost.

In one exemplary model, data of a set of engines from a maintenance and repair database is used to calculate the sunshine costs. For each engine, conditions found during maintenance that require module overhaul and that are not considered primary failures (e.g., failures that result in removal of the engine from the wing) are associated with the primary failures using a set of rules derived from the order in which the engine is disassembled given the primary failure.

Most of the individual engine modules and components typically last much longer than the average operating time between engine removals. A value is associated with the individual engine module at the time of engine build and a residual value at the end of the ETOW. The difference is the cost of the engine module for the current build. The cost of overhaul of a specific engine module may be treated as a capital investment to be amortized over the life of the engine module. The cost model may use the reliability of the engine module at the current time based on its individual failure distribution to compute its value at the time the engine is being maintained. The initial value is the overhaul cost times the reliability (equal to 1 for a newly overhauled engine module). The reliability of the engine module at the end of the ETOW is used to compute the residual value. The difference between the initial value and the residual value is assessed against the current build as a “module use” cost.

Another cost element that may be included in the cost model is a cost associated with the risk of premature removal of the engine module. This cost can be computed for each engine module individually depending on its failure distribution and the operation time of the individual engine module. This cost is included as risk in the cost model. A fourth cost is a cost associated with the residual value of an engine module when it is determined that the engine module should be overhauled to improve cost performance, such as cost per engine flying hour. The residual value of a failed engine module is zero but, when a decision is made to overhaul an engine module when it has significant life left, it has value that is not used and therefore represents a cost. Other costs that may be included in the model are: costs associated with availability/non availability of the aircraft; transportation costs for the failed and replacement engines; cost of maintaining spares; cost of actual removal and replacement of the engine on the aircraft; engine test cost; and potential cost of functional check flights.

In one exemplary embodiment, the cost performance is a cost per unit operation time, such as cost per engine flying hours. In one particular embodiment, the cost model includes four cost components: engine module use cost, sunshine cost, risk cost, and residual value of operational engine modules for which a decision was made to overhaul. The cost per engine flying hour is computed by dividing the sum of the cost components by the expected failure free operation time.

Returning to FIG. 13, the cost is computed for each of the possible decisions regarding overhaul or non-overhaul of each of the modules and components. Once the costs are determined, at 1306, the method advances to 1308 and the system determines whether there are more work scopes to be evaluated. If there are more work scopes to be evaluated, another possible work scope is selected, at 1310, and the method advances to 1304. If there are no more work scopes, the method advances to 1312 and the system selects an enhanced work scope based on a selection criteria.

If the mechanical system includes thirteen modules and if there are no primary failures among the thirteen modules, a large number of possible work scope combinations exist (e.g. 2¹³ or 8192 combinations). For an engine module that has a primary failure, the decision to overhaul that particular module is assumed and the number of required computations is decreased by a factor of 2. The results may be presented graphically and a table is generated showing the enhanced work scope within the constraint of a minimum ETOW. For example, the minimum estimated time on wing (ETOW) may be set at 2000 hours, but can be set to whatever value is desired. Typically, the maximum achievable ETOW for an exemplary engine is above the minimum ETOW, such as above 2449 hours.

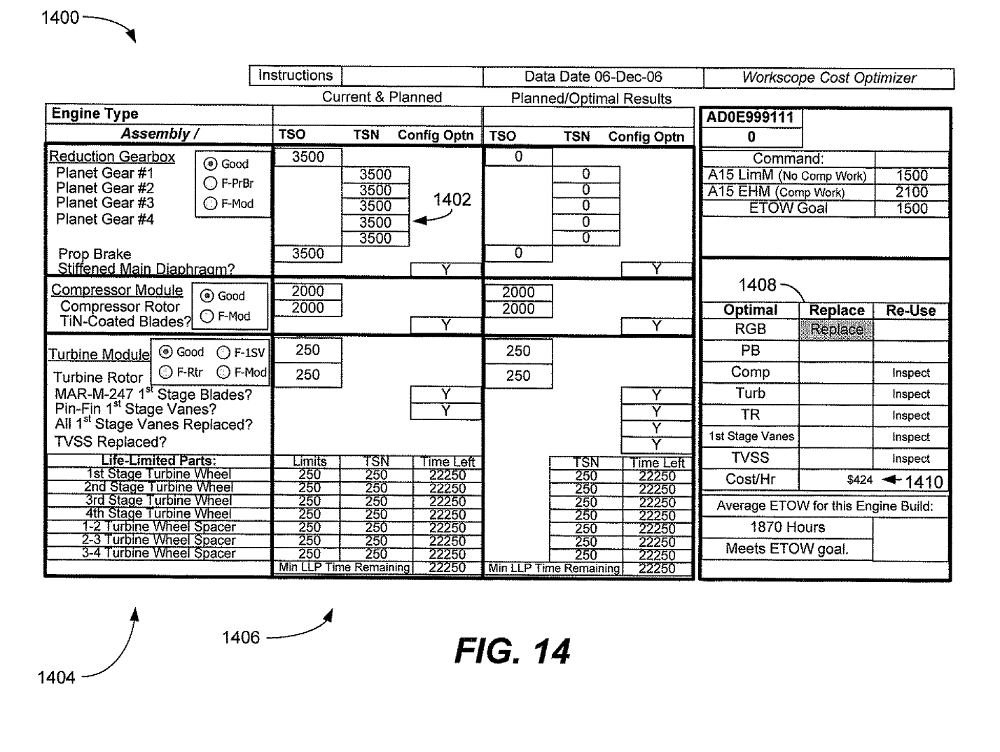

FIG. 14 is a diagram of a particular illustrative embodiment of a graphical user interface (GUI) 1400 including exemplary sunshine cost values. For example, an estimated cost of servicing components of the reduction gearbox indicates a cost of 3500, as indicated at 1402. Additionally, the GUI 1400 includes a list of life-limited parts 1404 and associated operating times 1406. The GUI 1400 may also include a list of particular components 1408 to be inspected or replaced. In a particular example, the GUI 1400 may be representative of a screen shot of an interface associated with a predictor tool, such as the work scope tool 126 illustrated in FIG. 1. Operation times associated with the engine modules can be entered into the predictor tool. Times for the modules that are included in the primary work scope or for which a decision is made to overhaul may be entered as zeros. The GUI 1400 may also include a result from a cost estimation, as indicated at 1410.

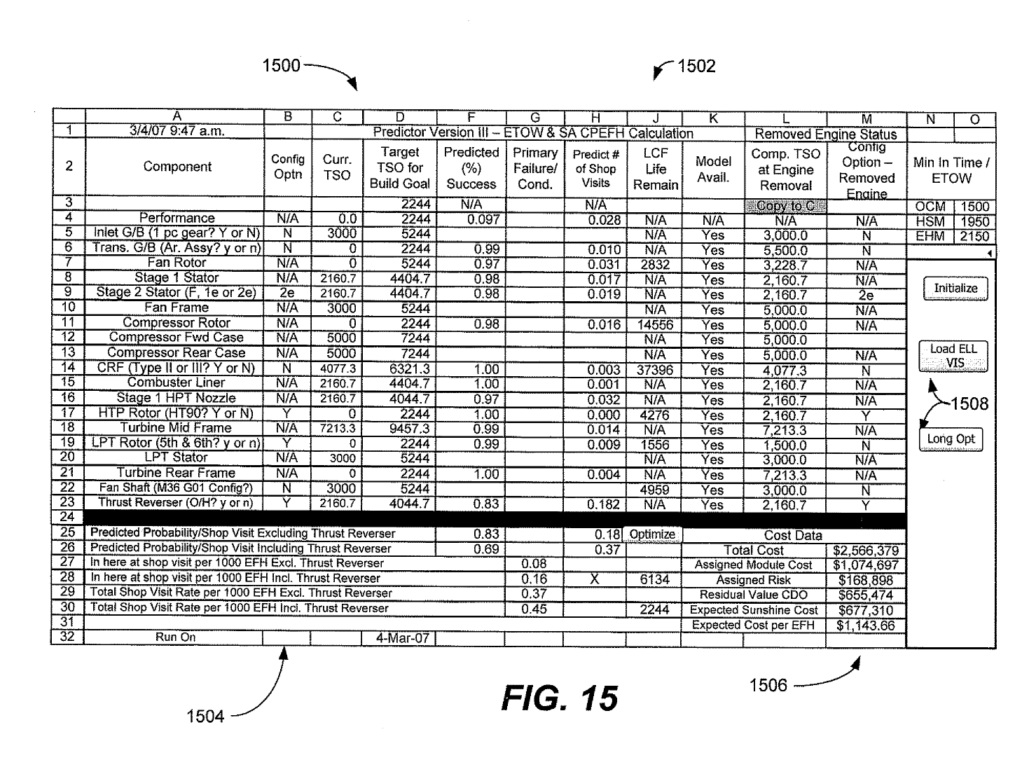

FIG. 15 is diagram of another particular illustrative embodiment of a graphical user interface (GUI) 1500, which may representative of a screen shot of an interface associated with the predictor tool, such as the work scope tool 126 illustrated in FIG. 1. The GUI 1500 includes a list of life-limited components 1502. For example, a fan rotor component may have a remaining life of 2832 units, which may be measured in hours, cycles, other units, or any combination thereof. The GUI 1500 can also display predicted values 1504 and estimated cost data 1506. The GUI 1500 may also include selectable indicators, such as buttons 1508, which may be selected by a user to initialize the GUI 1500, to load data into the system from a stored file or from a diagnostic device, to configure options, to access other functions, or any combination thereof.

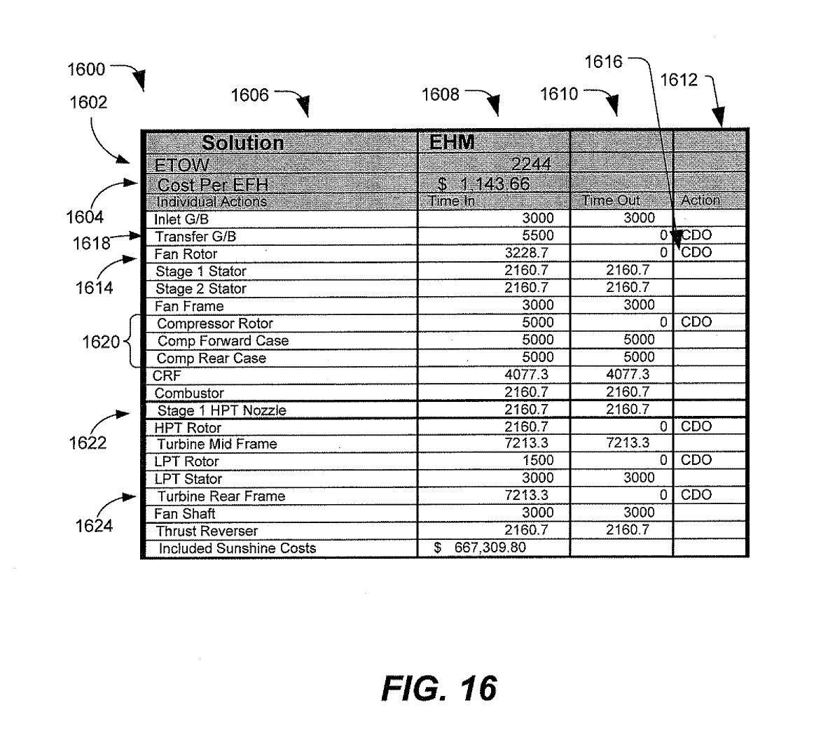

The first example presented is a relatively high time engine (i.e., an engine that can remain in service for a relative long period of time) that is removed after 2161 hours on a wing. A primary failure is assumed in the fan rotor and second stage stator. Upon further inspection, another primary failure is found in a high-pressure turbine (HPT). These three modules may be designated for overhaul because of the primary failures. Examples of cost model results (cost per engine flying hour versus time on wing) are illustrated in the estimated cost data 1506 and in the table 1600 illustrated in FIG. 16.

FIG. 16 is a diagram of a particular illustrative embodiment of a table 1600 illustrating results of a cost driven work scope optimization. The table 1600 includes an estimated time on wing (ETOW) 1602, a cost per estimated flight hour (EFH) 1604, and a list of possible individual actions 1606. Each item in the list of possible individual actions 1606 has an associated time-in 1608, an associated time out 1610, and an associated action 1612. In this particular example, the particular engine has an ETOW 1602 of approximately 2244 hours.

The associated time-in 1608 can represent an estimated number of hours until the part is expected to require maintenance. Certain actions, such as a maintenance operation for a Fan Rotor, generally indicated at 1614, may be selected for maintenance based on cost estimates. Such maintenance items may be identified for a Cost Driven Overhaul (CDO) as indicated at 1616 within the associated actions 1612. Such maintenance tasks may be performed on still-functioning components because of reliability or life-limited components.

Referring again to FIG. 16, in addition to primary failed modules, the transfer gearbox indicated at 1618, compressor 1620, 1st stage HPT nozzle 1622 and turbine rear frame 1624 are to be overhauled. For the purpose of this example, the compressor 1620 is assumed to include the compressor rotor and the two compressor cases. A Management Directed Overhaul (MDO) for the compressor 1620 includes the cost of overhauling the forward and aft cases as well as the rotor.

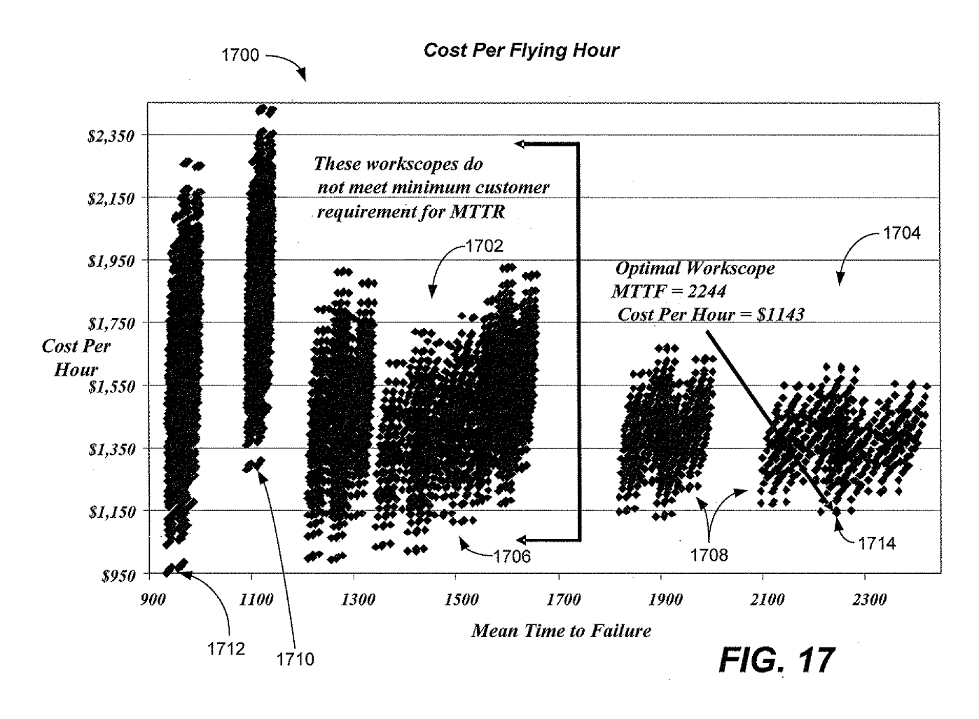

FIG. 17 is a graphical representation of a particular illustrative embodiment of a cost-based output 1700 with each dot (generally indicated at 1702 and 1704) representing a cost per hour relative to a mean time to failure associated with a particular work scope. In this particular example, a minimum customer requirement for mean time to repair (MTTR) for an engine may be 1699 units. In general, the 1699 units may be measured in hours, cycles, other units, or any combination thereof. In general, the work scopes associated with the dots 1702 do not satisfy the MTTR of 1699 units required by the particular customer. In contrast, the work scopes associated with the dots 1704 may satisfy the MTTR of 1699 units.

In general, each point on the cost-based output (chart) 1700 represents a specific work scope decision. Each particular work scope decision includes an estimated cost per flying hour for the particular engine if the particular individual maintenance tasks of that work scope are performed. In this particular example, there are a total of 1024 possible decisions (i.e., 2¹³/2³). In general, there may be 2¹³ possible maintenance tasks and three primary failure points among 13 modules of the system. In the cost-based output 1700, the two major clusters shown at 1706 and 1708 are typical for high time engines. The cluster 1706 represents those work scope options that do not call for overhaul of the compressor and the cluster 1708 on the right represents those work scope options that do. The two minor clusters 1710 and 1712 on the lower right represent work scope options that do and do not call for overhaul of the HPT rotor. The work scope represented by a dot 1714 represents a desired work scope (which may sometimes be referred to as an “optimal” work scope), which provides a lowest cost per hour for a highest number of hours (i.e., highest MTTR value) relative to the other possible work scopes. Accordingly, the work scope at 1714 may be selected to perform maintenance on the particular engine.

In a particular example, a total of $765,935 for sunshine costs that may be discovered when the engine is disassembled can be included in the cost of the enhanced work scope, as is a total of $224,204 to compensate for the residual value of the transfer G/B, compressor, 1st stage nozzle and turbine rear frame. The enhanced work scope is the planned work-scope and the final work-scope actually performed on the engine may contain an average of $765,935 dollars (the value of the sunshine costs) in additional overhauls.

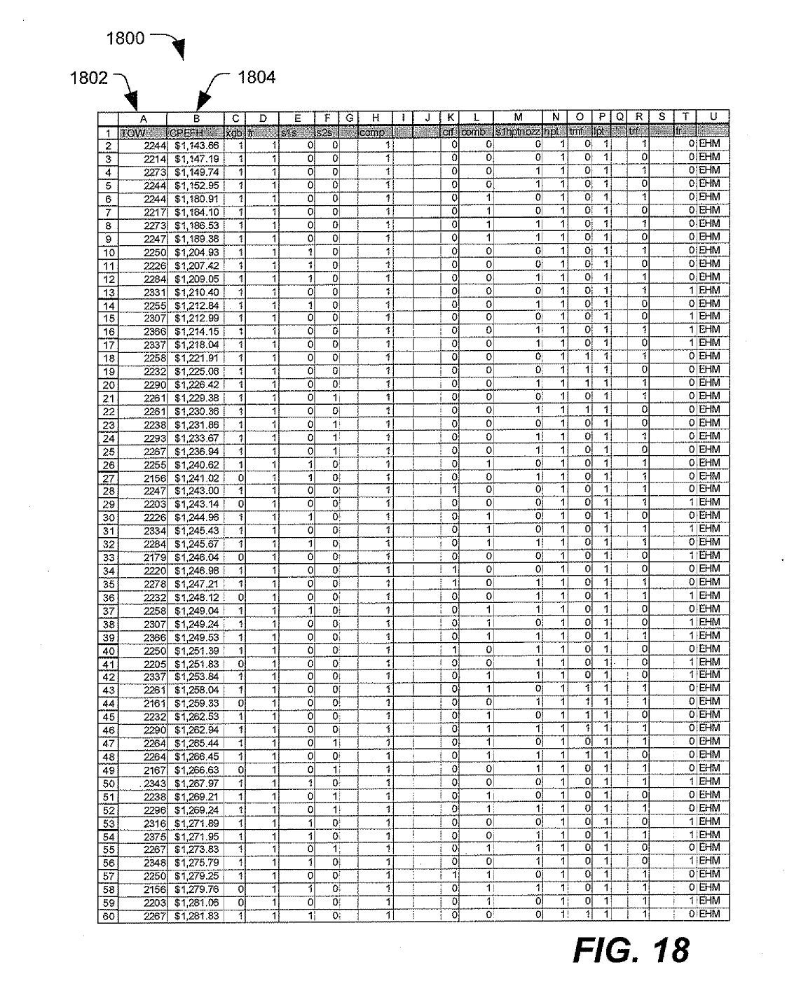

FIG. 18 is a graphical representation of a first 60 entries in an exemplary entry table 1800 illustrating results of applying a particular work scope to a particular mechanical system, such as an aircraft engine. The results of the particular work scope are shown in terms of the work performed and the resulting time on wing (TOW) 1802 and associated cost per engine flying hour (CPEFH) 1804.

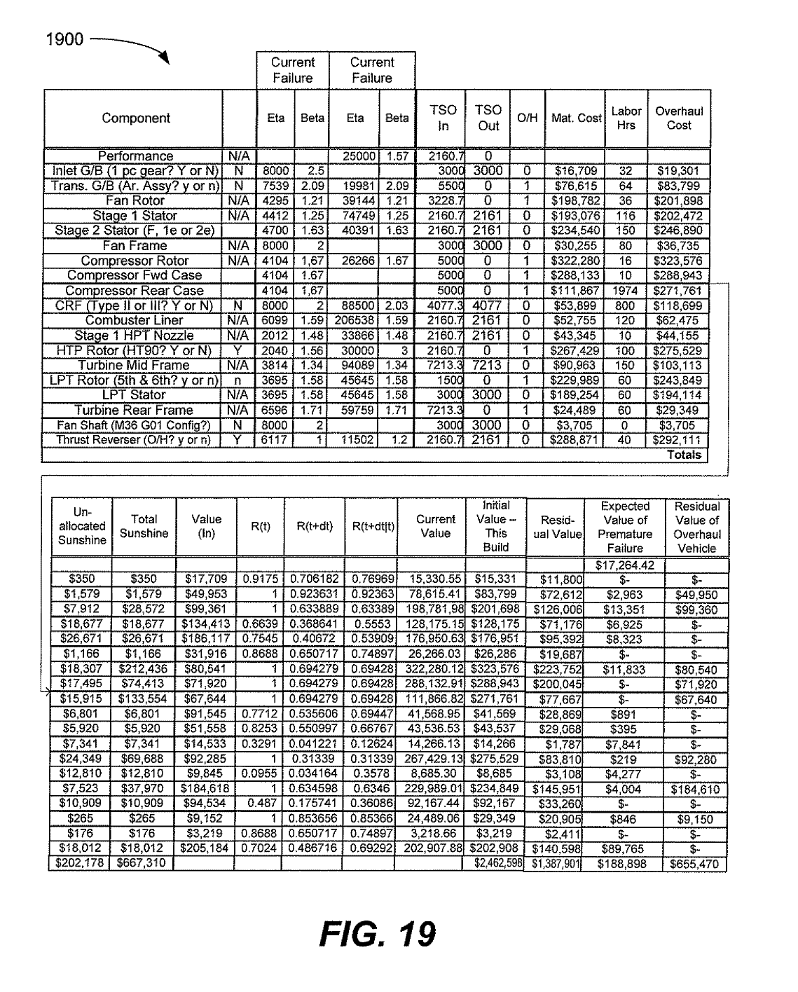

FIG. 19 is a table 1900 of a particular illustrative embodiment of data related to one of the work scopes illustrated in FIGS. 17 and 18. The table 1900 includes data related to reliability and cost computations for the particular work scope, including total sunshine costs, unallocated sunshine cost, overhaul costs, and residual value of overhauled modules. Generally, the total cost is not to be interpreted as a shop visit cost. It represents the cost assigned to this particular work scope and includes the “module use” cost for each module used in the build. It also includes an “assigned risk” element that represents the expected value of pre-mature shop visits based on the reliability of the modules involved.

In a particular example, embodiments of the above-described methods may be implemented using a spreadsheet. In a particular example, the model can be implemented by:

1. Entering the incoming operation times of the various modules and components in the predictor tool worksheet;

2. Identifying the items that are primary failures;

3. Identifying those items that will be forced to overhaul (typically the same as the primary failures);

4. Clicking an ETOW button to display the expected result of the specified or primary work scope- that is, the results of only overhauling those items that were identified for overhaul, such as ETOW and costs;

5. Clicking an “Optimize” or “Enhance” button provided within a graphical user interface to initiate determination of an enhanced work scope. In a particular example, the system can iteratively process multiple possible work scopes and associated costs to produce an enhanced work scope table. In one implementation, the model may take several minutes to run depending on the speed of the computer and the number of items forced to overhaul. In one example, the cost vs. Time-on-Wing (TOW) sheet (illustrated generally in FIG. 18) can be updated with blocks of data, such as after each 100 cost/ETOW estimates are completed. Costs may be determined using a cost model, such as the cost model spreadsheet illustrated in FIG. 19; and

6. Reading the enhanced work scope. The Enhanced work scope may be presented in a table. The possible work scopes may be presented on a chart. In one embodiment, if details of another solution are desired, the particular work scope can be highlighted on a chart (such as the diagram illustrated in FIG. 17) or within a table (such as the table 1800 in FIG. 18), the cost and ETOW noted and the work scope is then illustrated on a worksheet titled “tow vs. cpefh” (time on wing vs. cost per engine flying hour, generally illustrated in FIG. 18). This table can contain a list of possible work scope solutions and can be sorted by cost per engine flying hour (CPEFH), time on wing (TOW), other variables, or any combination thereof. A “1” in the column for a specific module means that that the module was overhauled for that particular data point, as illustrated in FIG. 18.

Particular embodiments of the systems and methods yield work scopes that are consistent with the intuitive notion that there is a point at which it is more economical to overhaul an engine module than re-use it. Rather than set soft or hard times for the individual engine modules, the system considers the engine as a whole and recommends actions based on cost. The enhanced work scope generally represents the initial work-scope plan and the minimum work to be accomplished on the engine. The final tasks performed on a particular engine often include a wider work scope than the primary or enhanced work scopes. The costs associated with broadening of the work scope are included in the cost model as “sunshine cost,” but that work is not specifically defined when the work scope plan is initiated. Costs associated with the actual work scope and failure free operation times of the engine after the actual work scope is performed may be fed back to the models to enhance future estimations. 1001151 The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-rewritable memory. Additionally, the computer-readable medium can include a magneto-optical or optical medium, such as a disk, a tape, or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The illustrations of the embodiments described herein are intended to provide a general understanding of the structure of the various embodiments and are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced.

The above-disclosed subject matter is to be considered illustrative, and not restrictive, and the appended claims are intended to cover all such modifications, enhancements, and other embodiments, which fall within the true spirit and scope of the present invention. This disclosure is intended to cover any and all subsequent adaptations or variations of various embodiments. Combinations of the above embodiments, and other embodiments not specifically described herein, will be apparent to those of skill in the art upon reviewing the description. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising.
receiving a primary work scope comprising a set of tasks associated with maintenance of a mechanical system, the mechanical system including life-limited parts;
generating a set of work scopes for the mechanical system, each work scope of the set of work scopes including the primary work scope and at least one additional task associated with maintenance of the mechanical system, wherein at least one work scope of the set of work scopes includes a maintenance task related to the life-limited parts;
estimating an operating time and a cost performance parameter for the mechanical system based on each work scope of the set of work scopes; and
providing an enhanced work scope, the enhanced work scope having an operating time that is greater than a threshold.

2. The method of claim 1, wherein the enhanced work scope includes an enhanced cost performance parameter.

3. The method of claim 1, wherein the mechanical system includes a set of components, the method further comprising receiving historical data associated with individual components of the set of components.

4. The method of claim 3, wherein the historical data includes a number of cycles in operation of each individual component.

5. The method of claim 1, wherein the mechanical system comprises an engine.

6. The method of claim 1, wherein the mechanical system comprises an aircraft engine.

7. The method of claim 1, wherein providing the enhanced work scope comprises:
identifying a subset of work scopes of the set of work scopes, each work scope of the subset of work scopes having an operating time that is greater than the threshold; and
providing a work scope of the subset of work scopes that has an associated cost that is less than an associated cost of other work scopes of the set of work scopes.

8. The method of claim 1, wherein estimating the operating time comprises:
estimating the operating time of the mechanical system based on a reliability model which includes statistical failure distributions according to historical data, wherein the expected operating time is obtained by integration of the overall reliability curve from zero to the time remaining for the life-limited component having the lowest remaining time.

9. The method of claim 1, wherein the life-limited part comprises a component having a predetermined service life.

10. The method of claim 9, wherein the predetermined service life is assigned by a manufacturer of the component.

11. The method of claim 9, wherein the predetermined service life is assigned by a regulatory agency of an industry that utilizes the mechanical system.

12. The method of claim 1, wherein generating the set of work scopes comprises:
a) selecting one or more additional tasks associated with maintenance of the mechanical system that are not included in the set of tasks;
b) generating an enhanced work scope including the primary work scope and the one or more additional tasks; and
c) repeating a) and b) iteratively to produce the set of work scopes related to possible combinations of the primary work scope and additional tasks.

13. A system comprising:
a work scope generator to receive a primary work scope comprising a set of tasks related to maintenance of a mechanical system and to generate a set of work scopes, each work scope of the set of work scopes comprising the primary work scope and at least one additional task associated with maintenance of the mechanical system, at least one work scope of the set of work scopes including at least one maintenance task related to a life-limited part;
a predictor tool to generate an estimated operation time of the mechanical system considering both statistical failure distributions and life-limited components and a cost performance parameter for each work scope of the set of work scopes; and
a work scope evaluation unit to receive the estimated operation time and the estimated cost performance parameter and to determine an enhanced work scope from the set of work scopes having an operating time that is greater than a threshold.

14. The system of claim 13, wherein the enhanced work scope includes an enhanced cost performance parameter.

15. The system of claim 13, wherein the life-limited part comprises a component of the mechanical system that includes a pre-determined life-cycle limit that defines an operating time limit for the mechanical system.

16. The system of claim 15, further comprising a graphical user interface to display a reliability model for each component of the mechanical system and to receive user input to adjust the reliability model for a particular life-limited part to produce an adjusted reliability model.

17. The system of claim 15, wherein the enhanced work scope includes a maintenance task associated with the life-limited part when a number of operating units of the mechanical system approaches the pre-determined life-cycle limit.

18. The system of claim 15, wherein the pre-determined life-cycle limit is defined by a manufacturer of the life-limited part.

19. The system of claim 15, wherein the pre-determined life-cycle limit is specified by a regulatory agency.

20. A method of performing reliability analysis for components of a mechanical system, the method comprising:
accessing failure data related to a plurality of components of a mechanical system;
performing a reliability analysis for each of the plurality of components of the mechanical system based on the failure data;
providing a graphical user interface to display a reliability analysis related to a life-limited component of the plurality of components and to receive user input related to an end of life indicator to adjust the reliability analysis of the life-limited component; and
generating a reliability model of the mechanical system using the adjusted reliability analysis which includes the impacts of failure distributions and life-limited components.

21. The method of claim 20, wherein the reliability model comprises an estimated operational time related to the mechanical system and wherein the expiration of the time remaining on the shortest lifed component drives the overall reliability function to zero.

22. The method of claim 20, further comprising: accessing operational data associated with the plurality of components, the operational data including failure and non-failure data; and generating a suspension representation of the mechanical system in response to accessing the operational data.

23. The method of claim 20, further comprising: performing simulations of the mechanical system using the reliability model to produce simulation results; and comparing the simulation results against historical data to validate the reliability model.

24. The method of claim 20, wherein the life-limited component comprises a part having a predetermined service life.
